(19) United States
(12) Patent Application Publication
(10) Pub. No.: US 2019/0012745 A1
(43) Pub. Date: Jan. 10, 2019

(54) Method and System for Reporting Location Information and Time Information of an Employee

(71) Applicant: PwC Enterprise Advisory cvba, Sint-Stevens-Woluwe (BE)

(72) Inventors: Floris AMPE, Sint-Stevens-Woluwe (BE); Frédéric SOUCHON, Sint-Stevens-Woluwe (BE)

(21) Appl. No.: 16/068,916

(22) PCT Filed: Jan. 11, 2017
(86) PCT No.: PCT/IB2017/050118

§ 371 Date: Jul. 10, 2018

(30) Foreign Application Priority Data
Jan. 11, 2016 (BE) 2016/5015

(51) Int. Cl. G06Q 40/00; H04L 29/06; H04W 4/029

(52) U.S. Cl. CPC G06Q 40/123; H04W 4/029; H04L 63/0861

(57) ABSTRACT

The present invention relates to a computer-implemented method for the reporting to the server of location information and time information of an employee within the framework of a tax declaration, in which said method comprises: determining an identity of the employee by means of a mobile device that is associated to said employee; determining said location information of the employee based on a localization of said mobile device, in which the location information comprises a first and a second location; determining time information comprising a first and second period of time by means of said mobile device, in which the employee is subject to a first tax authority linked to the first location during the first period of time and is subject to a second tax authority linked to the second location during the second period of time; registering said location information and said time information on said mobile device; transferring said registered location information and said time information to said server within the framework of said tax declaration.

### TECHNICAL DOMAIN

The invention relates to the reporting of location information and time information of an employee within the framework of a tax declaration relating to several jurisdictions or countries

### STATE OF THE ART

Depending on the situation in which they are, international employees must be able to demonstrate in their tax declaration that they effectively have worked a particular number (or percentage of the total number of) days in the tax year at a particular location.

A problem with the known methods for determining the tax arrears is that in the known methods, the location where an individual is located, is not determined regularly. U.S. Pat. No. 8,458,058 describes a method and system for determining the tax arrears as a result of a mobility. However, the present document focuses on individuals that have changed their place of residence, but cannot handle international employees, that regularly change their place of residence and/or workplace. For international employees, it is after all necessary that the location/place of residence where they are located, is determined regularly, as it is the period at that location that determines the part of the tax arrears. Hereby, it is necessary that the employees are identified/authenticated unambiguously by the device that also determines the location, i.e. the whereabouts of the employee have to be registered regularly. Moreover, with the present systems, one can also easily commit fraud, as the determination of time and consequently of period is often based on the time determination of a mobile application, which does not necessarily indicate the right time.

However, the system must be provided with sufficient security means for the privacy of the employee.

The present invention aims to find a solution for at least some of the above-mentioned problems.

There is a need for an improved method that unambiguously identifies international employees and links an independent time registration to a regular determination of the location of an employee. The employee can use this information as legal evidence for his tax declaration. In this way, he can moreover also avoid the related administrative work with receipts and other similar documents.

The invention aims to simplify the tax declaration filed by international employees. For the corresponding mobile application, the security, the ease of use and the respect of the privacy of the user are essential.

The applications that are described below, will solve the above-mentioned problem and make use of a ‘core module’ for making it easier for the tax payer to prove necessary matters to treasury. Therefore, the application will, at predetermined (working) days, automatically determine the location of the user, save it and eventually deliver the report accepted by treasury as a result of which demonstrating the work location of the employee in tax declaration has been simplified greatly and the required amount of administration has been much reduced.

### SUMMARY OF THE INVENTION

According to a first aspect, the present invention relates to a computer-implemented method for reporting to a server location information and time information of an employee within the framework of a tax declaration, in which said method comprises:
determining an identity of the employee by means of a mobile device belonging to said employee;
determining said location information of the employee based on a localization of said mobile device, in which the location information comprises a first and a second location;
determining time information comprising a first and second period by means of said mobile device, in which, during the first period, the employee falls under a first tax authority linked to the first location and during the second period, falls under a second tax authority linked to the second location;
registering said location information and said time location on said mobile device;
transferring said registered location information and said time information to said server within the framework of said tax declaration;

characterized in that said determination of the identity comprises a biometric authentication based on a biometric template, in which said biometric template is present only on said device, in which said registration of said location information and said time information takes place at least once a day, and in which said determination of the identity, location information and time information and said registration takes place without said mobile device being linked to said server.

Such method is very useful for an employer and/or employee when filing a tax declaration. When carrying out the method, a report be obtained in an efficient way with an overview of the locations where the employee has stayed within a particular period. This report is obtained in a more efficient way than is possible according to the state of the art. Moreover, in the method, the resulting reporting is more reliable than a reporting obtained with a method according to the state of the art. This is particularly the result of the use of a three-factor-verification, which provides for a biometric authentication, in addition to the determination of the location and reliable period.

Biometric authentication increases the reliability of the method. When following an employee, it could indeed be advantageous for the employee to transfer his authentication data to a third party. This must be prevented because it reduces the reliability of the method. A solution for this problem is biometric authentication, in which the identity of the user is controlled in a user-friendly way. A related further advantage of the method relates to the use of a biometric template. This allows the employee to authenticate locally instead of having to transfer confidential data via a connection with the server at every authentication. An important advantage is that a faster and safer authentication is possible.

Another advantage of the present method is the user friendliness. This is the result of the way in which the three-factor-verification has been developed. By allowing to determine and register the location information and the time information without any connection to the server, the employee can also make registrations without a network connection. Also, the employee can authenticate himself without being connected to the server. This is the result of the use of a biometric template that has been saved locally on the mobile device. By comparing the biometric template to new data, the authentication can take place on the device itself. This is particularly advantageous in the context of the present invention, because the employee is active under several tax authorities, which can cause connection problems, and possibly also for example (roaming) costs. Moreover, a method that does not depend on a permanent connection to a server is in any case more robust and more usable than a method according to the state of the art, in which data are transferred directly to a server. Another advantage of the present method is that, thanks to the use of a reliable form of authentication, it is not necessary to determine the identity of the employee at each registration of location information and time information. This is more user-friendly, as a result of which the employee will be more inclined to carry out the authentications as much as possible. This, in turn, leads to a better, more reliable reporting.

In a preferred embodiment, said determination of time information takes place based on a source for independent time determination, such as a certified time source or a GNSS (global navigation satellite system). It is advantageous compared to a method according to the state of the art, in which the period is determined based on an internal clock of the mobile device. The latter is problematic as it is possible to allow the employee to change for example the clock of the mobile device, as a result of which the reporting as to the time information because unreliable. A solution is to work with a certified time source or a GNNS, such as for example a GPS, as provided for in the present invention. A preferred embodiment, in which the GNSS is used for determining not only the time, but also the location, has the additional advantage that the mobile device must address less interfaces. This is advantageous for the battery life of the mobile device.

In a further preferred embodiment, the registration of said location information and said time information takes place at least twice an hour, preferably at least three times an hour. The advantage is that the accuracy of the reporting increases. Also, the mobile device does not have to connect to the server at each registration, increasing the robustness, and which can also be advantageous for the battery life. By disconnecting the biometric authentication and the registration of location information and time registration, the high frequency of registering also does not lead to problems for the employee. The high frequency indeed does not force him/her to authenticate every time. This is also the result of the use of biometric authentication, allowing a higher security and thus a low frequency of authentication.

In a further preferred embodiment, the request for said biometric authentication at said employee takes place at least partially without the employee being able to predict this, and preferably at least once a month. In an exemplary embodiment, said request is as a result also made according to a time scheme that is determined at least partially by the system. In this way, the employee can never judge in advance with certainty if in a particular period, the authentication will be asked. This is advantageous, because it can help to prevent possible abuse.

In a further preferred embodiment, the request for said biometric authentication at said employee is triggered by said registration of location information, preferably when detecting a change of a tax authority linked to said location information. Such embodiment is advantageous, because an essential aim of the invention, the automatic determination of a change of tax authority in time, is linked to a manual confirmation of the employee. This clearly increases the reliability of the reporting.

In a further preferred embodiment, the request for said biometric authentication is made less frequently as the level of trust corresponding to said employee increases, in which said level of trust depends at least on the validity of a number of recent biometric authentications, such as the validity of the three most recent biometric authentications. Such embodiment also has the advantage that the employee is not bothered more frequently than is necessary. This increases the user-friendliness. Moreover, it leads to a larger willingness of the employee to authenticate if necessary. This in turn leads to a higher reliability of the resulting reporting.

In a further embodiment, said registering of said location information and said time information comprises an indication of a validity of a present and/or recent biometric authentication. The advantage is that the three-factor verification typical of the invention is more balanced. It is indeed not that a lack of authentication leads to non-registration of location information or time information. Rather, the registration simply continues, and afterwards, it is determined if the data for which no recent authentication is available, are sufficiently reliable. This leads to a more flexible and more complete form of reporting, increasing the quality of the report.

In a further preferred embodiment, said determination of the identity comprises a first local authentication mechanism concerning said biometric authentication and said determination comprises a second local authentication mechanism concerning a PIN authentication. An advantage of such a combination is that this enables a so-called “positive recognition”, in which the improper use of one digital identity by more than one person is avoided. In this way, the input of the PIN can confirm the digital identity, and delivers the biometric authentication, e.g. a fingerprint, the evidence that it effectively deals about the one person that is linked to said digital identity. In an alternative embodiment, this allows several persons to determine this identity, location information and time information via the same device and/or the same mobile application. In such an alternative embodiment, the PIN constitutes a unique identification of the employee in the system, and the fingerprint is his/her “signature” confirming this identity. The advantage of such an embodiment is that several employees can make use of the same mobile device. This is advantageous because the employee is less dependent on the correction operation of his own device. For example, it helps to avoid problems with the battery or correction operation of the mobile application particular types of devices, for example older devices. It also allows employees to use a common device that can for example be placed permanently at a side belonging to the employer of said employee. The latter decreases the barrier for the employee to carry out said method, leading to more reliable registrations.

In a further preferred embodiment, said determination of the identity takes place according to FIDO (Fast Identity Online) Alliance UAF specification set (Universal Authentication Framework) and/or U2F specification set (Universal Second Factor) comprising a first local authentication mechanism and optionally a second local authentication mechanism, in which said first local authentication mechanism relates to said biometric authentication, and in which said second local authentication mechanism relates to the use of a PIN and/or a dongle, preferably a USB dongle. The advantage of following a known specification set is the larger availability of facilitating tools, as well as the lager familiarity and the related larger trust at the employees and users. In an alternative embodiment, said second local authentication mechanism, whether or not within the framework of the FIDO (Fast Identity Online) Alliance UAF specification set (Universal Authentication Framework) and/or U2F specification set (Universal Second Factor), relates to the use of a SIM card (Subscriber Identity Module) and/or a HSM (Hardware Security Module).

According to another preferred embodiment, said localization is obtained by means of a GNSS such as GPS (Global Positioning System) and/or GSM triangulation (Global System for Mobile Communications). Both said techniques have the advantage that they offer a reliable and broadly available way of offering localization, with a large availability of interfaces present in mobile devices of the present generation.

In another preferred embodiment, said determination of identity, location information and time information and said registration takes place without said mobile device being connected to the Internet. In such an embodiment, authentication takes place locally and/of authentication is postponed until the connection has been restored. This is advantageous because it further increases the robustness of the method. By not depending on a data connection, the reporting is less dependent on circumstances, and the mobile device also has a longer battery life.

In another preferred embodiment, said determination of identity takes place only locally on the mobile device, and said determination of location information and time information takes place only based on an interaction between said mobile device and a GNSS. In such a specific embodiment, longer periods can be bridged in which the mobile device is not connected and still registers data in a reliable way. An example of such a period is for example a long trip by plane in which the mobile device is in airplane mode. In such case, all network connections are typically switched off, but there is for example still receipt by means of GPS.

In a second aspect, the present invention relates to a system for the reporting to a server of location information and time information of a plurality of employees within the framework of one or more tax declarations; said system comprising a server and a plurality of mobile devices; said server and each of said plurality of mobile devices comprising a processor, tangible non-volatile memory, instructions stored on said memory for controlling said processor, a mobile application; in which for each mobile device, the mobile application is configured for carrying out a method according to the present invention. Such a system has the advantage that many employees can be followed by means of one single server or back-end.

In a preferred embodiment of said system, an identity of an employee for at least one of the employees is linked one by one to the mobile application on the mobile device belonging to said employee. This has the advantage that several employees can be followed more univocally, by following only the activity on one mobile device. This leads to a neater organization, and here a larger reliability.

In a third aspect, the present invention relates to a use of the method for the reporting to a server of location information and time information of an employee within the framework of a tax declaration according to the present invention in the system according to the present invention for the calculation of a tax arrears corresponding to said employee and/or an employer associated to said employee, in which said tax arrears relate to said tax declaration, and in which said tax arrears is calculated at least partially based on said reporting to the server of location information and time information of said employee. Such use offers many advantages with respect to the existing practice of manually keeping up with the location. Such manual keeping-up is in practice indeed often time-consuming, and often leads to errors in the reporting. This is solved by the present invention.

### DESCRIPTION OF THE FIGURES

FIG. 1 shows an embodiment of a schema of the interaction between the (international) employee and the management module of the system.

FIG. 2 shows an embodiment of a schematic representation of the management module.

FIG. 3 shows an example of the level of trust based on the time and an example of the frequency of the controls based on the level of trust.

FIG. 4 shows examples of valid and invalid days in a concrete example.

FIG. 5 shows an example of a possible schema for biometric authentication and for registration of location information and time information.

FIG. 6 shows an example of architecture of a system according to the present invention.

FIG. 7 shows a first view of an example of an embodiment of a web application corresponding to the present invention.

FIG. 8 shows a second view of an example of an embodiment of a web application corresponding to the present invention.

FIG. 9 shows a third view of an example of an embodiment of a web application corresponding to the present invention.

FIG. 10 shows a fourth view of an example of an embodiment of a web application corresponding to the present invention.

FIG. 11 shows a fifth view of an example of an embodiment of a web application corresponding to the present invention.

FIG. 12 shows a sixth view of an example of an embodiment of a web application corresponding to the present invention.

FIG. 13 shows a seventh view of an example of an embodiment of a web application corresponding to the present invention.

FIG. 14 shows a eighth view of an example of an embodiment of a web application corresponding to the present invention.

FIG. 15 shows a ninth view of an example of an embodiment of a web application corresponding to the present invention.

FIG. 16 shows a tenth view of an example of an embodiment of a web application corresponding to the present invention.

FIG. 17 shows an eleventh view of an example of an embodiment of a web application corresponding to the present invention.

FIG. 18 shows a twelfth view of an example of an embodiment of a web application corresponding to the present invention.

FIG. 19 shows a thirteenth view of an example of an embodiment of a web application corresponding to the present invention.

FIG. 20 shows a first view of an example of an embodiment of a mobile application corresponding to the present invention.

FIG. 21 shows a second view of an example of an embodiment of a mobile application corresponding to the present invention.

FIG. 22 shows a third view of an example of an embodiment of a mobile application corresponding to the present invention.

FIG. 23 shows a fourth view of an example of an embodiment of a mobile application corresponding to the present invention.

FIG. 24 shows a fifth view of an example of an embodiment of a mobile application corresponding to the present invention.

FIG. 25 shows a sixth view of an example of an embodiment of a mobile application corresponding to the present invention.

### DETAILED DESCRIPTION

Unless otherwise specified, all terms used in the description of the invention, including technical and scientific terms, shall have the meaning as they are generally understood by the worker in the technical field of the invention. For a better understanding of the description of the invention, the following terms are explained specifically.

A ‘trusted time source’ is a source for an independent time stamping, for example based on certified time stamping of a ‘Global Positioning System’ (GPS) time.

The term ‘push notification’ refers to a message that is sent to a device belonging to an employee, typically by means of a real-time message showed on a screen of the device of the employee, for example a mobile device, within the framework of an application, for example a mobile application. Such push notification can invite the employee to perform an action. An example of such an action is an authentication of the employee, who identifies himself by means of a fingerprint on the screen of the device. This identification is linked to a particular time. This can be done based on a time stamping independent from the time indication on the device, for example based on a trusted time source.

The term ‘international employees’ refers to persons living in a first country, but working in a second country, of to persons working temporarily abroad (such as expats).

The term ‘core module’ refers to an application that can determine with a certain degree of certainty if a particular person is present at a particular location at a particular time. This application is preferably integrated in other applications (and thus does not exist on itself). This module is implemented in the form of a web application offering a web service via a clearly structured and documented API. This module can be adapted and updated easily (i.e. carry out updates).

According to another aspect, not meant to limit the present invention in any way, the invention relates to the determination of a tax arrears of an international employee, with a corresponding method and a corresponding computer-implemented system. In this respect, both the location and the corresponding time are determined regularly. Based on this information, the period is determined in which an international employee has stayed at a particular location. This information can be used to complete a tax declaration. In this respect, the time is determined by a reliable time source to avoid fraud. According to this further aspect, the invention relates to a method for filing a tax declaration of an employee, comprising:
receiving information of a taxable fact;
determining an identity of the employee;
determining location information of the employee, in which the location information comprises a first and a second location;
determining a first and second period by means, in which, during the first period, the employee falls under a first tax authority linked to the first location and during the second period, falls under a second tax authority linked to the second location;
determining a first tax arrears with respect to the first tax authority and determining a second tax arrears with respect to the second tax authority, in which the first tax arrears is based on the first period and a first tax rate of the first tax authority and the second tax arrears is based on the second period and a second tax rate of the second tax authority;
communicating a total tax arrears to the employee;

in which the identity and the location information are controlled at least once a day by means of biometric authentication.

The generic core module, ensuring the certified registration of the location of the users, comprises in a possible embodiment:
a generic, mobile software development kit (SDK) one the one hand, that can be integrated in very diverse mobile applications requiring a certified location registration; and
a back-end application,
   receiving the location data of the mobile core module, processing, securing and offering them via web services to the back-end application of the actual applications (e.g. My Tax Locator); and
   ensuring the required communication to the mobile applications (e.g. Notifications via push notifications).

The mobile applications comprise in a possible embodiment:
a mobile application (e.g. thin client) that
   uses the above-mentioned core module to deliver the required data for particular applications to the back-end application;
   offers an environment in which the user, dependent on the kind of application, can request an overview of his locations or can manage his settings.
a back-end application (e.g. web application) that
   offers the possibility to the user to set up particular things of to obtain an official report of his registered locations; and
   offers the possibility to the managers to manage the application.

The core module necessarily has the object to determine in a incontestable way the identity, location and time (three factors) of a user and to send this information to the underlying web application for storage and further processing.

In order to be able to guarantee these three factors (identity, location and time) with sufficient certainty, the application provides the following aspects:
strong initial authentication of the user (e.g. via eID);
strong link between the user and the mobile device (e.g. via biometric authentication);
strong link between the mobile device and the location (e.g. geolocalization via the GSM network or GPS); and
strong time window (e.g. via certified time servers).

The core module has to support one or more biometric authentication mechanisms to be able to determine the identity of an employee. If an application supports several mechanisms, it is possible (for an employer and/or for the system manager) to set up for each application which mechanisms can be supported and which aren't. The core module further supports one or more geolocation mechanisms, such as the GPS system or a location determination based on the GSM network. Hereby, the required accuracy of the location determination can further be set up.

Furthermore, the core module also supports one or more mechanisms for time stamping. This time stamping takes place by means of a trusted time source. If the application supports several mechanisms for time stamping, it can be set up for each application which mechanisms have to be used.

It is essential that the core module offers a certified location registration, ascertaining the identity of the user. The identity control, or authentication, takes place in many contemporary mobile applications by means of passwords or pin codes. These security methods only offer a limited protection and passwords or pin codes can easily be passed on to third parties.

In the case of for example the applications of the present invention, the end-user does take advantage of being able to transfer his authentication data to third parties and hence stronger authentication mechanisms are required. For these applications, it is thus very important that we can guarantee, with sufficient certainty, that the person that has registered initially, effectively is the person using the application. A possible solution is the use of ‘biometric authentication mechanisms’, in which the identity of the user is controlled in a user-friendly way. Some examples that can be used in this application, comprise:
scan of the fingerprint, via a sensor on the mobile device or via the built-in camera;
facial or iris recognition via the camera at the front of the mobile device (possible using a camera capturing the movement of the employee);
speech recognition via the built-in microphone of the mobile device;
ear recognition via the camera or the touch screen of the mobile device (e.g. Descartes Biometrics);
blood vein recognition;
ECG/heart rhythm recognition;
recognition of the behaviour;
recognition of the active skin, i.e. by means of recognition of ultra-thin patches that cannot be removed with damage;
DNA matching.

Furthermore, a combination of several of the above-mentioned methods can be used for the authentication of an employee.

In a preferred embodiment of the invention, the employee is provided with a human implant that comprises e.g. A GSP chip with Bluetooth connectivity, or a coded RFID chip. This implant makes the biometric identification indeed superfluous.

The core module must also regularly determine the location of an employee. Since it is the location determination that will determine during which period the employee is liable to pay tax in a particular country, this location determination is essential and the location of an employee must be determined accurately.

Dependent on the application, the required accuracy of the location determination can vary strongly. As a result, it is possible to combine different geolocalization mechanisms with different accuracies (e.g. GPS vs. GSM localization) and to determine the most appropriate mechanism and have it set up. As a mechanism with a lower accuracy also has positive effects for the energy consumption, and related battery life, it will in the end also improve the final ease-of-use of the application. The exact determination of which mechanism(s) for location determination and associated technical solution(s) are used in the application, can be set up dependent on the needs of employer and employee.

Alternatively, the location can be determined based on payments with credit cards or a tracer chip can be placed in the passport.

In a preferred embodiment of the method, the location of an employee can be transferred to family members in case of a disaster in the neighbourhood of one of the sites of the employer.

In the method of the present invention, regular time stamping is also essential (for example several times a (working) day). One also has to avoid that the time stamping can be tampered with, since it can falsify the eventual tax declaration. Hence, it may not be possible to determine ‘place-person’ pairs and, by adjusting the clock on the mobile device or by placing the device in ‘off line’ mode, to register oneself at a different time. Therefore, the core module only uses trusted time sources, that cannot be adjusted by the user. In this respect, this module can make use of:
trusted time sources;
the time stamping of the GPS satellite; or
the point in time when the ‘place-person’ pair arrives at the back-end system (provided the mobile device can send this pair immediately to the back-end, which is for example not possible without an active Internet connection).

The core module can comprise one or more of the above-mentioned time stamping methods.

In a preferred embodiment of the method, the authentication takes place at an arbitrary point in time. In this way, the user-friendliness remains high and the end-user does not risk to give his mobile device to another person. The frequency of the authentication can depend on the trust the application has in this employee, based on the authentication history of a particular employee. In this way, an employee that has responded correctly to requests for authentication in the past, will have to send his location less frequently to the application.

The method thus provides for a notification platform based on ‘push notifications’, enabling the user to be informed, via these notifications, of
the fact that the back-end system has not yet received a valid location registration for that day;
the location registration has (not) been completed successfully;
an authentication of the users is required with respect to the system;
the fact that there are new updates;
etc.

The application can be connected to the managing system of the managers by means of cellular networks. Alternatively, use can be made of networks requiring a lower capacity (such as Lora or Sigfox). The latter networks have indeed the advantage that they are relatively cheap, offer a worldwide coverage and have a relatively low energy consumption.

In a preferred embodiment of the invention, the application, carrying out the method, can estimate the activities of the employee by means of sensors in the mobile application. In this way, the application can estimate if the employee is at work, on his way, is traveling, etc. (for example via Sentiance SDK).

The system that calculates the taxes, can work based on a home address, but it can also use the location where a employee has spent most of his time (several provinces/countries).

The method requires a mobile Software Development Kit (SDK), that can be integrated and used in mobile applications. The module is designed and implemented in a generic way, so that some settings can be adjusted, e.g. by means of an API interface. Adjustable settings comprise characteristics related to the authorized biometric authentication mechanisms, the parameters for determining the frequency of the arbitrary authentication moments, the used geolocalization technology (possibly determined automatically dependent on the desired accuracy), the used trusted time source (and the possible authorized deviation). The management module can also adjust the settings.

The mobile SDK and the back-end applications of this core module are designed and implemented so that the mobile SDK can also be set up and controlled completely from the on line available management module. Therefore, a secured communication between the mobile SDK and the management module is provided.

The method that is described here, can be applied to all standard operating systems, such as Android, iOS and Windows applications. This description is however not limiting for the chosen operating system.

The method and the related application are meant to provide a reliable solution for filing a tax declaration. In this respect, it is important that the application functions in accordance to the legal framework (i.e. the privacy legislation, tax legislation, eIDAS, . . . ). The operational part is also important, in which the monitoring of the availability (e.g. user statistics in e.g. Google Analytics), the management of problems and incidents, the management of the performances and back-ups is provided for.

The method must further be implemented in a safe environment, comprising safety with respect to the infrastructure, the user identification, the use and access management, ‘Jailbreak’ (i.e. enabling the charging of software application that are not recognized by the software supplier) and ‘root detection’, obfuscation of the code (i.e. Hiding the source code), data encryption, data integrity and incontestability, control track, etc. In this environment, it is also possible to maintain the module, amongst other things by adjusting it in case of updates of the underlying infrastructure (e.g. CMS, programming language, etc.) of the third party SDKs (e.g. obfuscation software, modules for logging information, etc.).

The method must also be user-friendly and reliable, this in respect to the accuracy of the fiscal reporting, the collection and sending of the data, the determination of an accurate time (time stamping), etc.

Next to the SDK for the integration in mobile applications, the core module used for the method also requires the support of a back-end management module. This management module ensures different aspects, comprising:
receiving, safely storing and possibly processing the information sent by the SDK;
delivering a report with info about working locations of the related user, determined by the core module;
generating and via web services making available of the required reports;
digitally signing the above-mentioned report (e.g. by means of an electronic identity card);
via web services making available of the processed and secured stored information to the back-end applications of the applications in which the ‘core module’ is integrated;
via web services offering an API to set up this ‘core module’ as required by the application in which it is integrated (in which the back-end of this application will provide for the actual user interface for the management), e.g.
   setting up the frequency and accuracy of the location determination, possible authentication mechanisms, etc.
   the required communication to the mobile applications (e.g. notifications via ‘push’ notifications);
   user management (i.e. adding, adjusting and modifying user data); and
   the general management of the ‘core module’ by an administrator via a very restricted user interface.t

The mobile SDK and back-end application of this core module are implemented so that the mobile SDK can be set up and controlled completely from the back-end application. Therefore, a secured communication between the mobile SDK and the back-end application is provided.

Next to the web services, a user interface is also provided for the administrator of the back-end application where some general items for both the back-end application itself and the mobile SDK can be set up. The infrastructure for this back-end application can e.g. be programmed in a .NET environment. This document is however not meant to be limiting as to the programming language that is used.

Since this ‘core module’ offers certified location registration to applications that want to make use of it, it is required that it can offer sufficient certainty as to the identity and location of the effective user and the point in time when this registration has taken place. Moreover, the back-end environment will also contain much personal and privacy-sensitive data, requiring protective measures that must at all time meet the requirements imposed by the government and other related parties.

The design and the implementation of this module must therefore, as much as possible and in accordance to the ‘industry best practices’, offer the necessary safety techniques. The following safety mechanisms are at least required:
secured storage of personal data;
secured communication to and from the mobile SDK;
integrity control; and
certificate pinning (HPKP).

The module is provided with the necessary tools and mechanisms for mapping the use and possible problems with the module. At least the following items must be monitored (and logged):
User statistics (e.g. Google Analytics);
Possible failure of the application;
(Un)authorized access to, modification of or removal of personal data.

Also, the necessary log functionality is provided, by which the detection of problems or ‘root causes’ in case of problems or possible abuse will be facilitated.

The method contributes to the automatic determination and generation of report accepted by the tax authorities with respect to the international working locations of employees with the aim to simplify tax declarations by minimizing the administration. To this end, the applications are built around the core module, enabling the certified location registration.

The method can display the following functionalities:
display of the status of the present day (e.g. location already determined, application switched-off, possible problems, etc.);
display of an overview of the registered locations in the (recent) past, preferably in calendar form, and
the possibility to set up particular items via the mobile application (e.g. switching off the application in case of holiday).

In a second aspect, the invention relates to a system for implementing the method of the present in invention.

In the context of this document, a “mobile device” refers to an electronic device for digital communication and/or information processing, such as a smart phone, a mobile phone, a tablet or a note book/laptop, which is preferably provided with a screen. Here, the term “mobile” refers predominantly to an exemplary use in which the device travels together with the employee, and must not be interpreted as limiting the scope of the present invention. A mobile device can for example also refer to a desktop computer. In some embodiment, the mobile device must moreover not travel together with the employee, as in a case in which several employees use one and the same device, which will also be described below. As in the latter case, it can be a device that is stationary, it will be clear that the term “mobile” must not be interpreted limitatively.

In the context of the present document, the terms “server”, “back-end” and “server back-end” are used interchangeably.

A “biometric implant” (also “template”) is a digital reference of different characteristics taken from a biometric sample. In an example in which these characteristics relate to a fingerprint of an employee, the biometric sampling consists of at least once showing the fingerprint at the initialization, from which said biometric template is determined. As soon as the biometric authentication is operational, the biometric template is compared to the fingerprint shown at the authentication, to determine if the fingerprint that is presented at that moment, corresponds to the fingerprint that was shown originally. If they correspond, the authentication is considered valid. If they do not correspond, the authentication is considered invalid. In a first example, the biometric authentication relates to the verification of a fingerprint of the employee, and the biometric template is a reference of characteristics of the fingerprint of the employee. In a second example, the biometric authentication consists of facial recognition applied to the employee, and the biometric template is a reference of characteristics of the face of the employee. In a third example, the biometric authentication comprises both fingerprint recognition and facial recognition, and the biometric template comprises characteristics of both the fingerprint and the face of the employee.

In the present document, localization preferably takes place based on a GNSS and/or GSM triangulation. Hereby, the term “GNSS” (Global Navigation Satellite System) refers to a satellite navigation system allowing localization, such as for example GPS, GLONASS, Galileo, Beidou and other regional systems. GSM triangulation refers to a technique in which one or more masts, preferably three or more masts, in the neighbourhood of the mobile device are identified. By quantifying and comparing the respective signal strengths of connections between the mobile device and the respective masts, one can determine the location of the mobile device. This technique works particularly well in regions where a large number of masts are present in the immediate environment.

In a preferred embodiment, said localization is 100 meter precise, more preferably up to 50 meter, and most preferably 30 meter. This means that a deviation at a particular location, for example expressed in two-dimensional coordinates, preferably is inferior to 100 meter, more preferably inferior to 50 meter, most preferably not more than 30 meter.

In a preferred embodiment, the present invention meets the European General Data Protection Regulation (GDPR) EU 2016/679, also known as the General directive concerning data protection. In this respect, protection is provided for person-related data of said employees and other interesting parties to which the invention is related.

In an alternative embodiment of the present invention, the different locations do not relate to different tax authorities, but to other demarcations of the space, and the tracked person for who location and time information is registered is not necessarily an employee, but he/she can also fulfil another role. A first example are check-ins at construction sites. The location that is important, is here the construction site. Hereby, the tracked persons are construction workers who register their presence at the construction site for being registered with respect to an authority and/or agency for social security. Another example is a certified location-as-a-service. This allows to deliver generic evidence for the presence of a tracked person at a particular moment at a particular place.

In the present invention, biometric authentication can take place without said mobile device being connected to said server. This is possible thanks to the use of a biometric template that has been saved locally on the mobile device. By comparing the biometric template to new data, the authentication can take place on the device itself. In a preferred embodiment, said biometric authentication also takes place at least partially according to a planning of a moment in time for authentication. At that moment in time that is not known in advance to the employee, a request for biometric authentication can be made to the employee, without the mobile device necessarily being connected to the server at that moment. The advantage is that it offers more flexibility to the employee: his/her mobile device must not be connected to the server to enable authentication.

In a preferred embodiment, said biometric identification comprises facial recognition. The terms “facial recognition” and “face recognition” are used interchangeably in this context.

In a further preferred embodiment, the request for biometric authentication takes place at moments in time taking into account a time schema of the employee. In this way, the system can for example ensure that requests for authentication are sent to the employee when he/she is at work. The advantage is that the employee is not bothered by work-related items when he/she is not at work. Also, the system can avoid that a request for authentication is being made at the moment when the employee is driving a car. As these is a good chance that the employee is moreover driving the car, it is for safety reasons better not to carry out authentication at that moment. Said time scheme can hereby be sent to the system by the employer. In a preferred embodiment, the time scheme is also at least partially drawn up based on measurements made by the system. For the example of the employee driving a car, the system can detect the driving by for example following the evolution of location information.

In the following, the invention will be described by means of non-limiting examples illustrating the invention. These examples are not meant or cannot be interpreted as limiting the scope of the invention.

### EXAMPLE 1

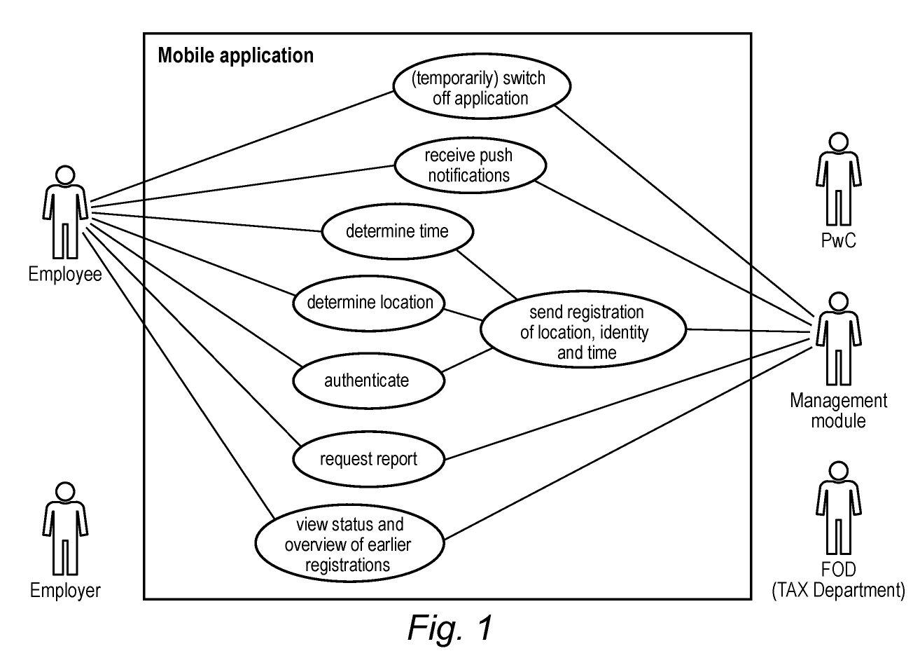

In FIG. 1, a scheme is shown of the interaction between the employee and the management module by means of a mobile application.

Hereby, the employee receives ‘push’ notifications if the application is switched on. For these push notifications, an employee receives a message on his mobile application, requesting to identify himself. An employee must e.g. leave a fingerprint on the screen of the mobile application. To this identification, a particular time (determined based on time stamping independent of the time indication on the mobile application, for example based on a trusted time source) and a particular location (determined by e.g. a GPS system) is linked. In a preferred embodiment, the application can run on the background, and the fingerprints are be taken while the employee is using his mobile application to other ends. The identification of an employee can be carried out by means of any possible advanced biometric identification (such as fingerprints, iris controls, voice recognition) unambiguously determining the identity of an employee.

An employee can also at any time request a report, giving an overview of his whereabouts. This overview can be useful for estimating the future tax declaration. An employee can in this way have a look at the status of the present tax period and also study an overview of the previous registrations.

### EXAMPLE 2

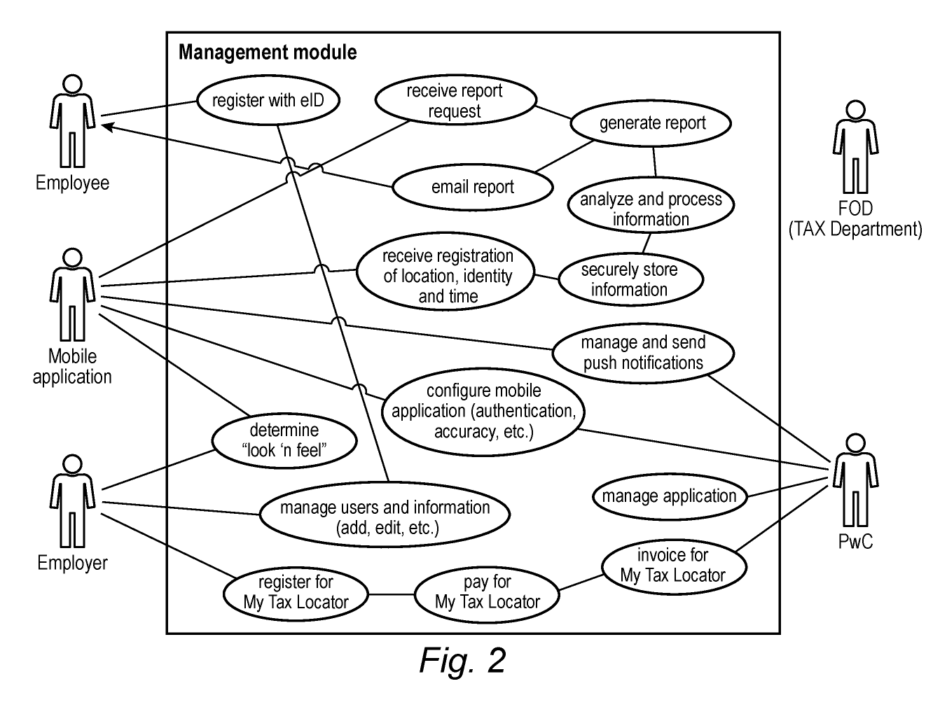

In FIG. 2, a flow chart is shown of an embodiment of a method carried out by the management module.

An employer must fist register himself in the system (now indicated as “My Tax Locator’). If the administrator of the system (here indicated as ‘PwC’) has invoiced this registration and the employer has paid the invoice, the employer can use the system.

The employees of the employer must register and identify themselves with an electronic identification means, such as for example the eID. The employer receives these identity data and must manage these data (if necessary, add and/or modify them). The employer can also adjust the view (‘Look ‘n feel’) of the application as he/she wishes.

The administrator ‘PwC’ of the system must set up the mobile application. It must for example be set up which authentication system (comprising fingerprints, iris control, speech or ear recognition, or a combination thereof) will be used. Also, the necessary accuracy of the position and time determination must be set up. The system of the administrator regularly (e.g. Daily or weekly, and preferably less frequent as the level of trust associated with the employee increases) sends push notifications via the mobile application to the employee. The latter must identify himself e.g. by means of a fingerprint. At this identification, the location and the time are registered, these data are stored safely and the data are analysed and processed. Based different registrations, the period is indeed determined in which an employee has stayed at a particular location. This period can be used later for correctly filing a tax declaration.

If an employee requests a report via the mobile application, this application generates the report and this report is sent to the employer via email.

It will be clear that the present invention is not limited to the embodiments that have been described above and that some adjustments or modifications can be added to the described examples still falling with the scope of the attached claims. The choice in the examples for a particular mechanism (as to authentication, localization or time stamping) must not be interpreted as limiting the invention.

### EXAMPLE 3

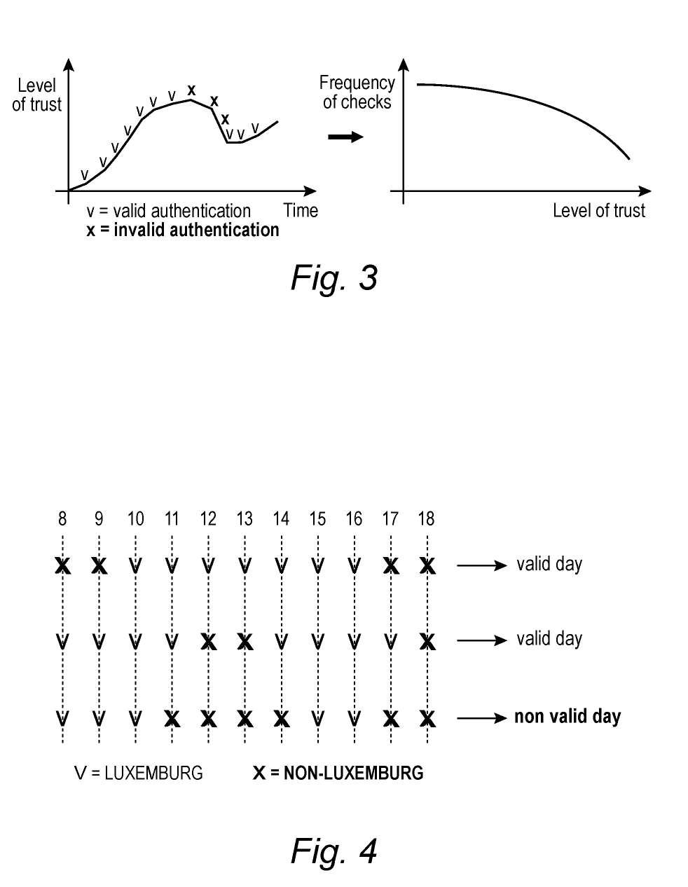

In FIG. 3 in the right pane, a frequency function (‘Frequency of checks’) is shown, indicating the number of requests for authentication based on the level of trust. In the left pane, the level of trust is shown in a period of time (‘time’). Hereby, employee builds the level of trust at valid authentications/identifications. However, if the employee has missed some checks, the level of trust decreases and this employee will again be checked more frequently, with a frequency determined as in the right pane. The parameters for the curve of the right pane can be set up by the employer and by the administrator. Such curves can be included in a report that is meant for tax authorities or related government. Preferably, said parameters are set up in coordination with this fiscal authority or related government, so that the latter would accept the generated report as a piece of evidence.

### EXAMPLE 4

In the following, an example is given of a possible application of the method. This application has as a target public employees living/working in Luxembourg, but respectively working/living in Belgium. The application will support these users, as described above, by automatically determining and storing their working location and by generating a report that is accepted by the tax authorities which they can add to their tax declaration as a piece of evidence of their working locations.

Since 17 Sep. 1970, a Belgian-Luxembourg treaty is in place for avoiding double taxation. It stipulates that employees living/working in Belgium, but respectively working/living in Luxembourg and not working for more than 24 days (or in proportion if it would concern a part time contact) in another country than the country in which they are employed, pay their taxes in the country in which they are employed. This application will have to use the biometric authentication mechanisms provided for in the above-mentioned core module, in order to be able to guarantee, with sufficient certainty, that the person of which the location is determined, is effectively the legitimate employee.

This application will have to use the location registration provided for in the above-mentioned core module, in order to be able to guarantee, with sufficient certainty, that the legitimate employee was effectively present at a particular location. By determining several times a (working) day the county in which the employee is located, the application can determine in which country this person has worked at that particular day.

In a specific example, the application can for example determine the country of the location of the user between 8 o'clock in the morning and 18 o'clock in the evening every 50 to 70 minutes (on average every hour, but spread to relieve the back-end server). Hereby, the accuracy of the geolocalization will be limited to avoid a possible violation of the privacy (e.g. a radius of 15 km around the effective location, or less when the user is situated close to a country border). Every day on which the user is in for example Luxembourg for 6 (or more) consecutive hours, will be registered by the application as a whole day worked in Luxembourg. This limit of 6 h has in this example be determined in such way to take into account persons arriving 5 minutes after a first location registration in Luxembourg en leaving again 5 minutes before the last registration, as well as to take into account employees working 1 or 2 hours at home to avoid queuing, etc. (see FIG. 4).

### EXAMPLE 5

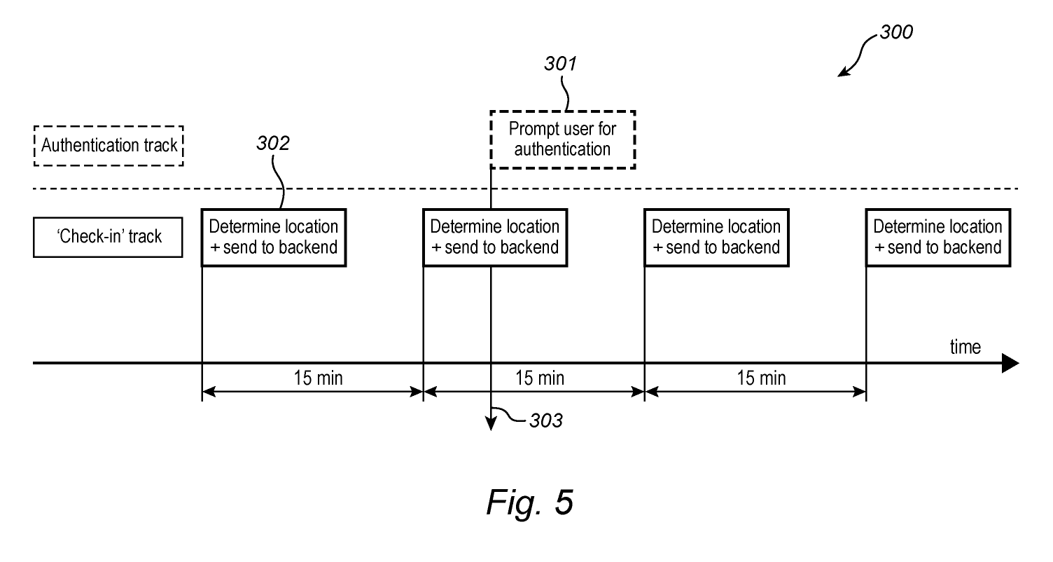

FIG. 5 shows an example of a possible schema 300 for biometric authentication and for registration of location information and time information of an employee according to the present invention. Hereby, the biometric authentication takes place according to a separate first track, the authentication track. The determination of location information and time information and the registration of these location information and time information takes place according to a separate second tack with check-ins, the check-in track. In FIG. 5, both tracks are plotted in function of time.
1. On the first track, the employee is asked for an authentication, with a “prompt user for authentication” 301. In a preferred embodiment, this takes place by means of a push notification on his/her mobile device, for example a smart phone. The moment 303 when this takes place, is preferably arbitrarily, and is preferably not chosen according to a fixed scheme. However, a typical frequency can in advance be configured, such as 5 times a day, or once a day/week/month, or any other desired configuration. Switching off the device can also be a trigger for authentication. Furthermore, the determination that the tax authority has been changed, can also be a trigger for the system for asking a new authentication. Long periods of inactivity or long periods in which the mobile device is off line, can also be a trigger. Furthermore, the level of trust can also be taken into account that is associated with said employee, and that increases as a larger part of the recent biometric authentications are valid.
2. On the second track, check-ins take place. Hereby, the term “check-in” applies, in which each new check-in 302 comprises the registration of the current location information and time information. In this example, the check-ins take place with a fixed interval of 15 minutes, however this value can also be higher or lower. The check-ins also do not have to take place with strictly fixed intervals, as long as they take place with high frequency. At each check-in, the registered data can also be sent immediately to the back-end, i.e. the server. However, this is only possible when at the moment of the registration, a connection can be made with the server. In other cases, for example when the mobile device does not have an Internet connection, the registered data are buffered locally. The location information and time information of one or more check-ins are then sent together to the server once a connection with this server is again possible.

Together, both tracks guarantee the correct reporting of location and time information of the employee to the server. As will be clear, there does not have to be a connection between both tracks, but a connection in which an event on the one track triggers an event on the other track is possible.

### EXAMPLE 6

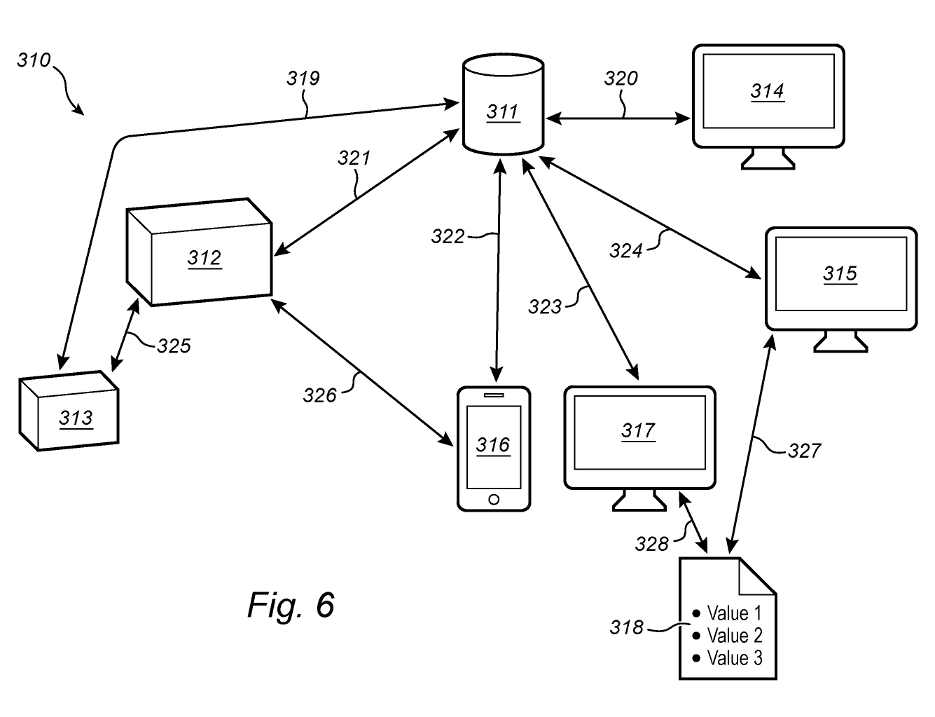

FIG. 6 shows an example of architecture of a system 310 according to the present invention. The system 310 comprises amongst other things a server (311, 312, 313) and a mobile device 316 associated with the employee.

The mobile device 316 is meant to be carried with the employee. Via this mobile device 316, location information and time information related to the employee be reported to the server.

The server essentially comprises three modules, that is an application module 311, a core module with SDK 312 and a biometric module with SDK 313. These three modules are mutually connected (319, 321 and 325) as a result of which they essentially work in a coordinated way. Each of the modules can be housed in a separate device, but one or more modules can also be implemented in the same device.

The core module 312 ensures in this respect the actual determination of location information and time information of an employee, and thus represents an essential aspect of the present invention. Hereby, it interacts 326 with the mobile device 316 of the employee. The location and time information that is registered by the mobile device 316, has to be reported to the server; this reporting preferably takes place in this interaction 326 with the core module 312. Further, the core module 312 comprises a software development kit (SDK) to enable the interaction 321 with one or more application modules, in this case one application module 311. Hereby, the core module 312 offers a generic service with respect to location information and time information of an employee, that can be relevant for diverse applications with diverse goals.

For determining the identity of an employee, the core module 312 interacts 325 with the biometric module 313. The biometric module 313 comprises in turn a software development kit (SDK) to enable the interaction 319 with one or more application modules, in this case the same one application module 311. The application module 311 essentially guarantees all tasks that have not been included by the core module 312, such as supporting the execution of a mobile application on the mobile device 316 of the employee, the delivery of push notifications to the employee via interaction 322 or the interaction with other parts of the system 310 via other interactions 320, 323 and 324. Said mobile application offers a graphical user interface (GUI) to the employ to request, dependent on the kind of application, for an overview and/or report 318 of registrations of location information and/or time information. This GUI also offers support when initializing the mobile application, in which amongst other things a biometric template has to be created.

Furthermore, the system comprises a second device 317 associated with the employee, optionally an HR-related device associated with a HR service (Human Resources) of an employer associated with said employee, and a supplier-related device 314 associated with the supplier of the application to said employee, and by extension said employer.

In a preferred embodiment in which an HR-related device 315 is present, both this device and the second device 317 of the employee allow to request an overview and/or report 318 of registrations of location information and time information. This is made possible by a web application with GUI offered by the application module via interactions 323 and 324. Hereby, typically, there is a more extensive information to the user of the HR-related device 317 than to the employee. The user of the HR-related device 317 can for example typically ask information with respect to several or even all of the employees belong to one of more employers. This is possible by setting particular rights in the system 310. These rights have to be set taking into account the privacy of all parties concerned.

Finally, the supplier-related device 314 interacts 320 with the web module 311. This takes place by means of a web application with GUI offered by the supplier, with again an associated adapted setting of rights in the system 310. This allows the supplier to modify particular settings of the system 310, such as the frequency and accuracy of the location determination, possible authentication mechanisms, the frequency and nature of communications to the mobile applications and user management.

### EXAMPLE 7

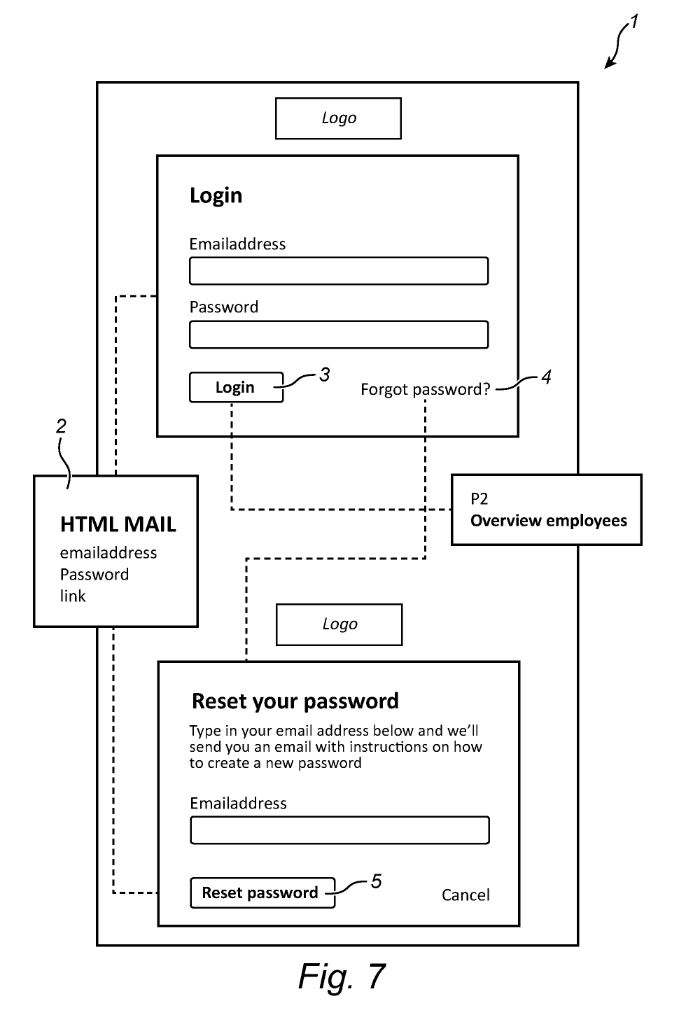

FIGS. 7 to 19 show diverse views of an example of an embodiment of a web application corresponding to the present invention. This web application, also called “customer console”, has the object of helping an employer when applying the system according to the present invention to his employees. The web application distinguishes in this respect two user roles for employees of the employer: “manager” and “staff”. A manager is a super user who has at least the same rights as a staff user, and who can, moreover, add and delete staff users. A staff user is a user who can add employees to use the system, and who can manage them. These employees do not come into contact with the customer console, but on the contrary with a mobile application, of which an example is given in EXAMPLE 8.

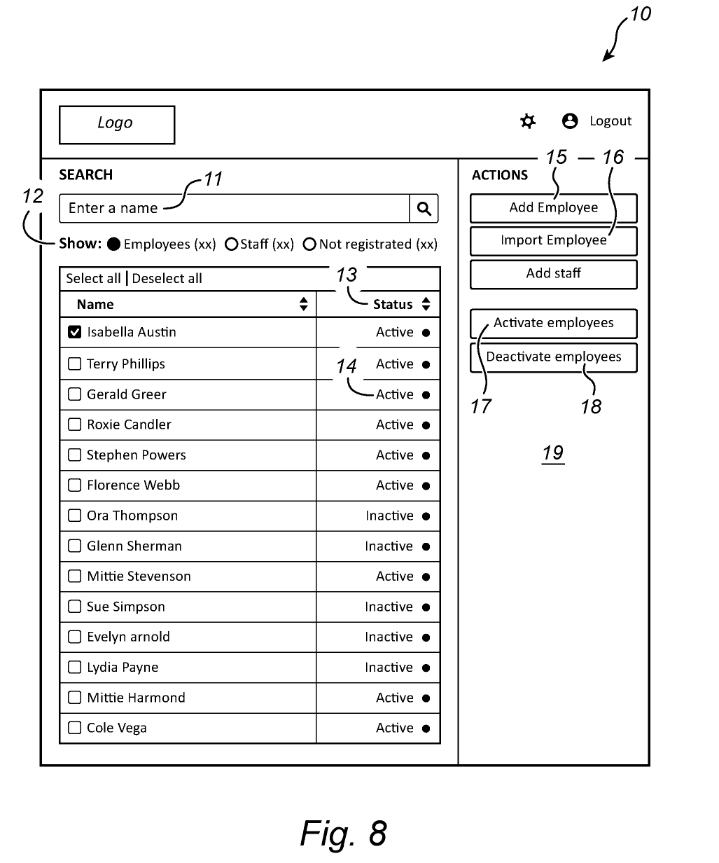

FIG. 7 illustrates the screen 1 with which one can log into the web application. Normal logging-in takes place via the fields “Email address” and “Password”, and clicking or touching the button Login 3. These three elements correspond to the indicated HTML MAIL 2. When the user has successfully been logged in, he/she sees the screen 10 with the overview of employees (FIG. 8). If the user has forgotten his/her account data such as the password, he/she can click on the link 4, and a dialog window “Reset your password” will be shown, where he/she can give in an email address, and clicking/touching the button “Reset Password” 5 gives a new password.

FIG. 8 illustrates the screen 10 with the overview of employees. Via a search bar 11, one can search for the name of employees. Radio buttons 12 can be used for filtering on the kind of employees, for example to show only employees that are staff. FIG. 8 shows hereby a view of employees. For each of the shown results, a status is also shown at each employee, in which the notifications “active” or “not active” indicate of the employee is logged in to use the mobile application or not. The heading 13 of the table allows to sort columns alphabetically. The action column 19 comprises several buttons with actions that can be applied to the names that have been checked in the list on the left of the action column 19. Dependent on which names have been checked, certain actions can be inactive. The button 15 allows to invite an employee via mail, in which the employee receives an invitation on his/her professional address and can start to use the mobile application. Button 16 allows to import one or more profiles of employees via a file, for example an excel file. Buttons 17/18 allow to activate/deactivate selected names.

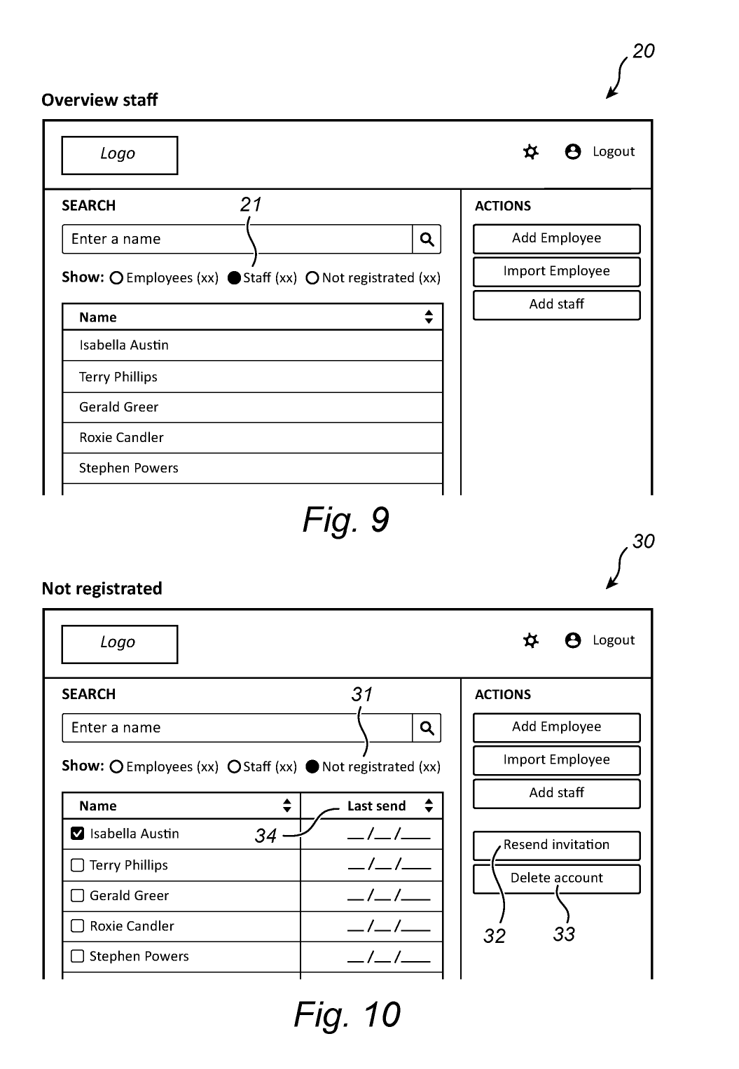

FIG. 9 illustrates the screen 20 with an overview of staff users. This screen is only available for manger users, and is obtained by selecting the radio button 21.

FIG. 10 illustrates the screen 30 with non-registered employees. This is obtained by selecting the radio button 31. Checked profiles of non-registered employees can again be invited via mail with an activation link via button 32. Checked profiles can also be deleted with button 33. The date of the last invitation can be seen in column 34.

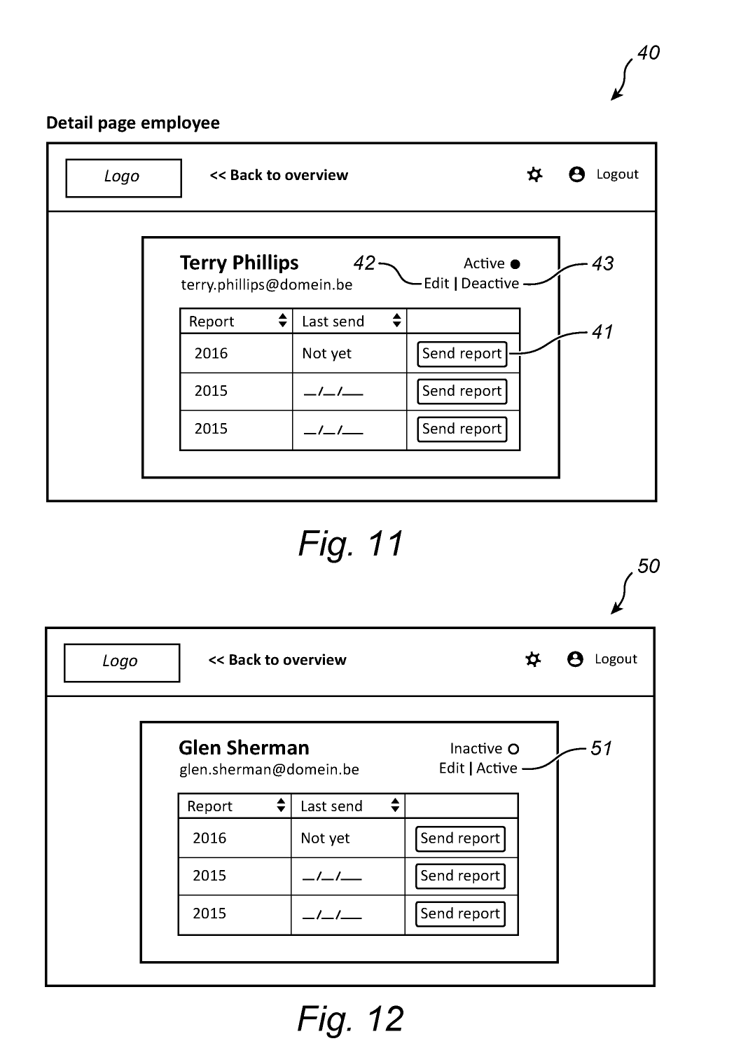

FIG. 11 illustrates the screen 40 with the detail of an employee. The button 41 ensures a report is sent to the employee; the button is only active when a report is effectively available for the particular period. The report relates to location information and time information of the employee for the period mentioned in the first column. The link 42 allow to adjust the professional email address of the employee; the link 43 allows to deactivate the employee.

FIG. 12 illustrates the screen 50 with the further detail of an employee. This screen is only available for manager users. Contrary to the screen 40, this screen allows amongst other things to re-activate a temporarily deactivated employee with link 51.

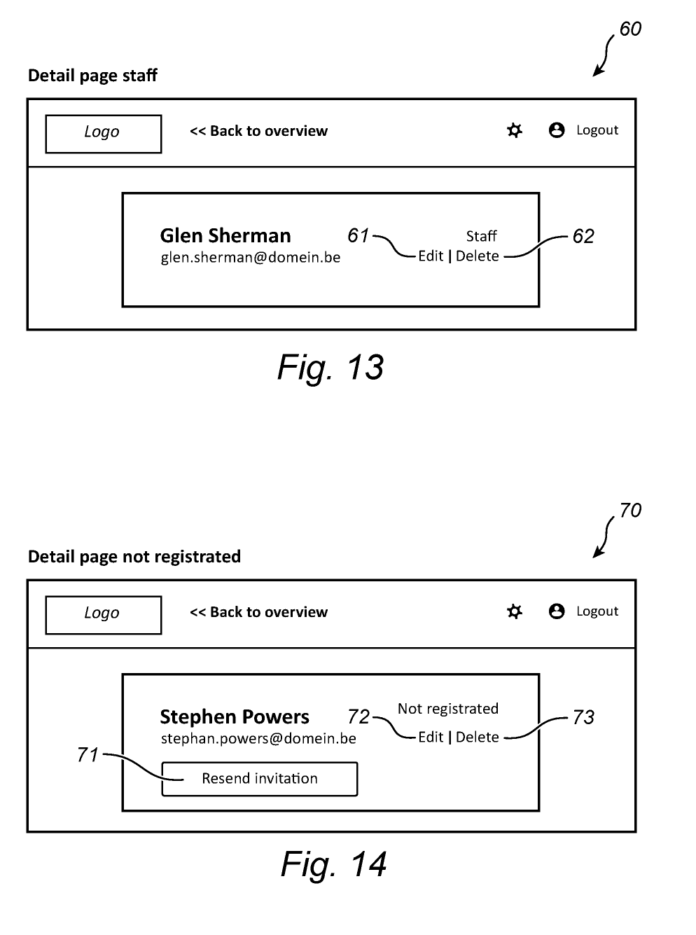

FIG. 13 illustrates the screen 60 with the detail of an staff user. This screen is only available for manager users. The link 61 allow to adjust the name and the professional email address of the employee; the link 62 allows to delete the profile of the staff user.

FIG. 14 illustrates the screen 70 with the detail of a non-registered employee. This screen allows to invite this employee again with button 71. The link 72 allow to adjust the name and the professional email address of the employee; the link 73 allows to delete the profile.

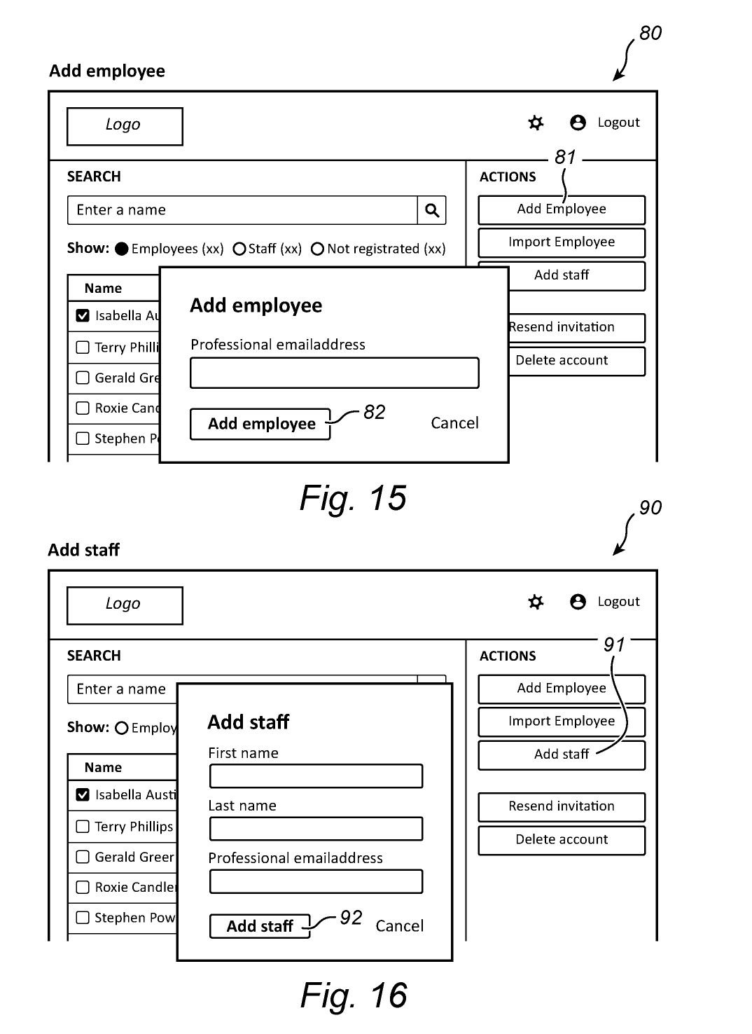

FIG. 15 illustrates the screen 80 that is obtained by clicking/touching the button 81 (in another view button 15). After entering the professional email address and clicking on the button 82, the employee receives an invitation via mail.

FIG. 16 illustrates the screen 90 that is obtained by clicking/touching the button 91. After entering the complete name and the professional email address and clicking on the button 92, the staff user receives an invitation via mail.

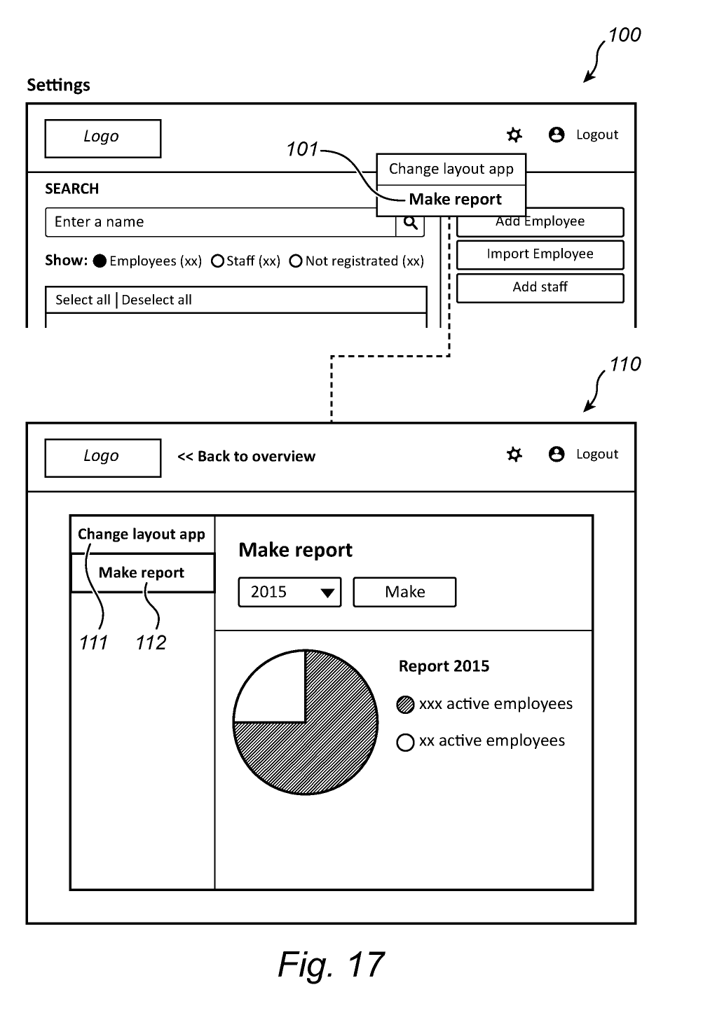

FIG. 17 illustrates the screen 110 with general settings that are obtained by choosing option 101 in the drop-down menu in screen 100. The screen 110 mentions as settings, changing the lay-out of the mobile application 111 and adjusting the settings for making reports 112.

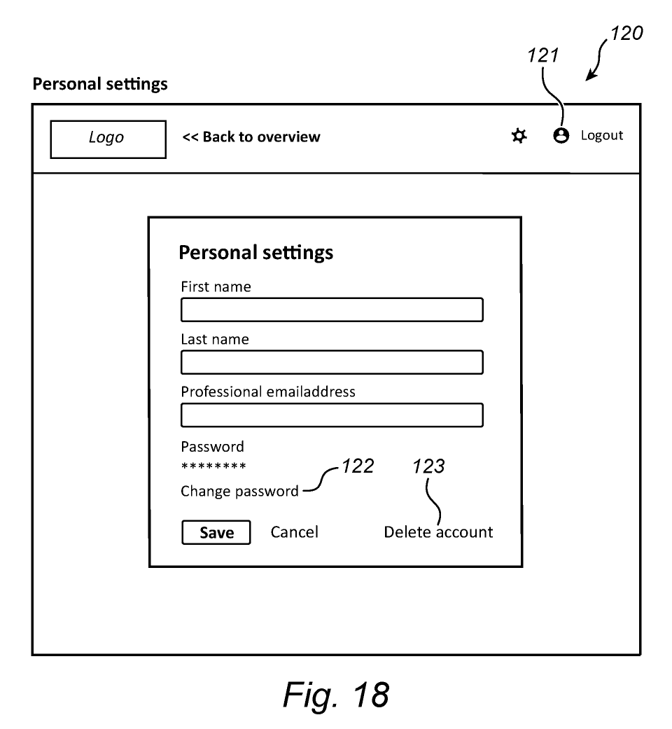

FIG. 18 illustrates the screen 120 that a user obtains by clicking/touching the zone 121. This allows the user to adjust his/her password via link 122. Via link 123, the user can delete his/her account.

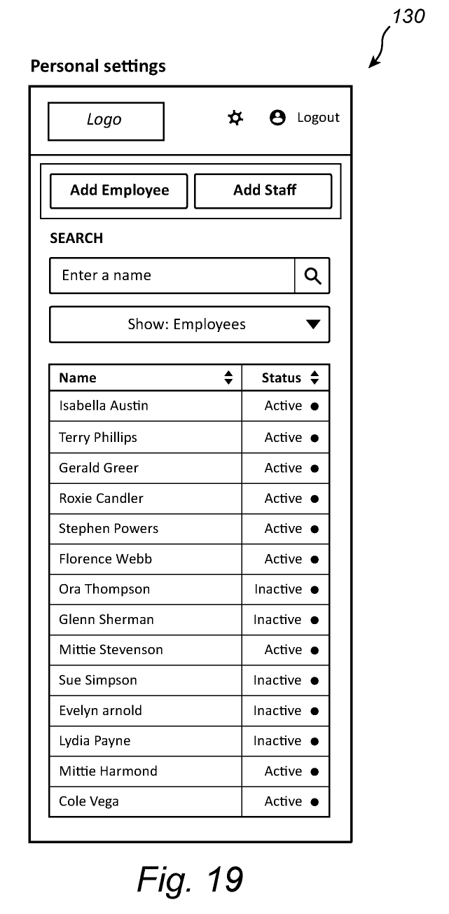

FIG. 19 illustrates the screen 130 with an overview of employees. Screen 130 is the mobile display of the screen 10, and essentially offers the same functionality, but arranged in a different way.

### EXAMPLE 8

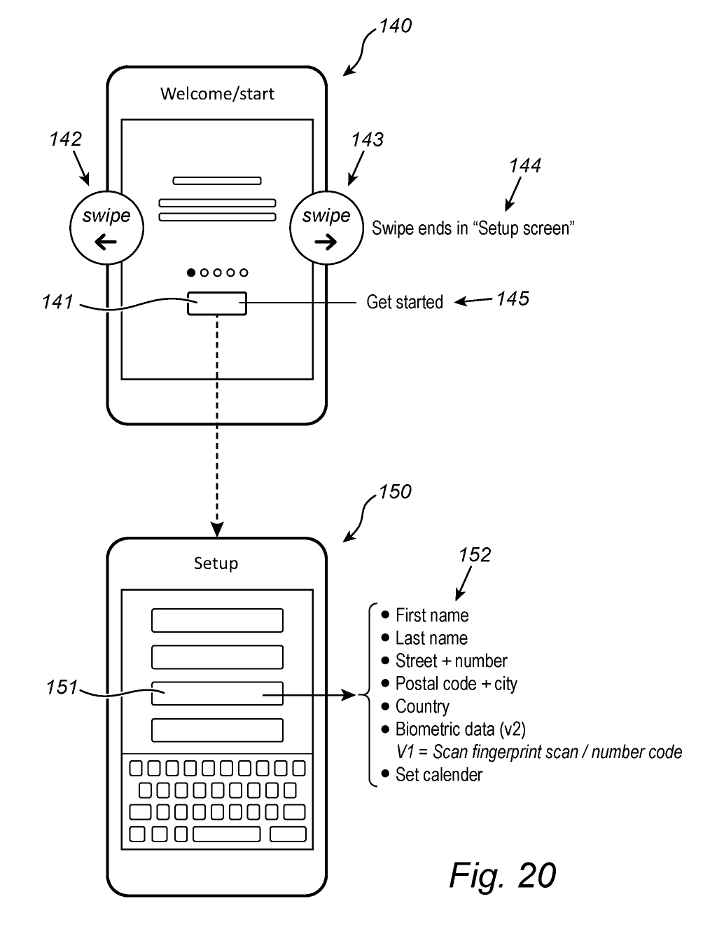

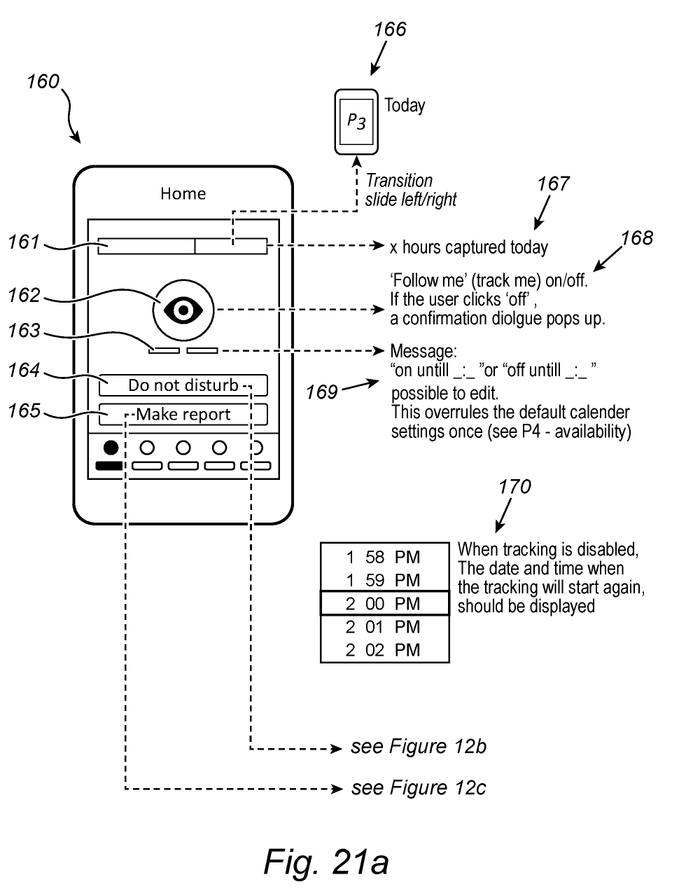

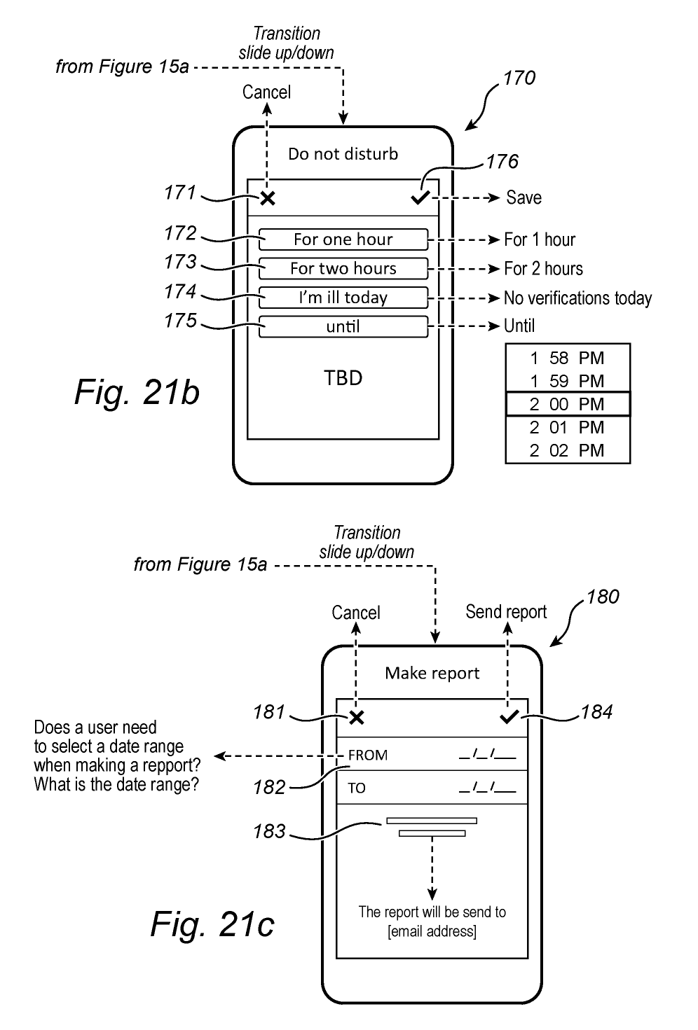

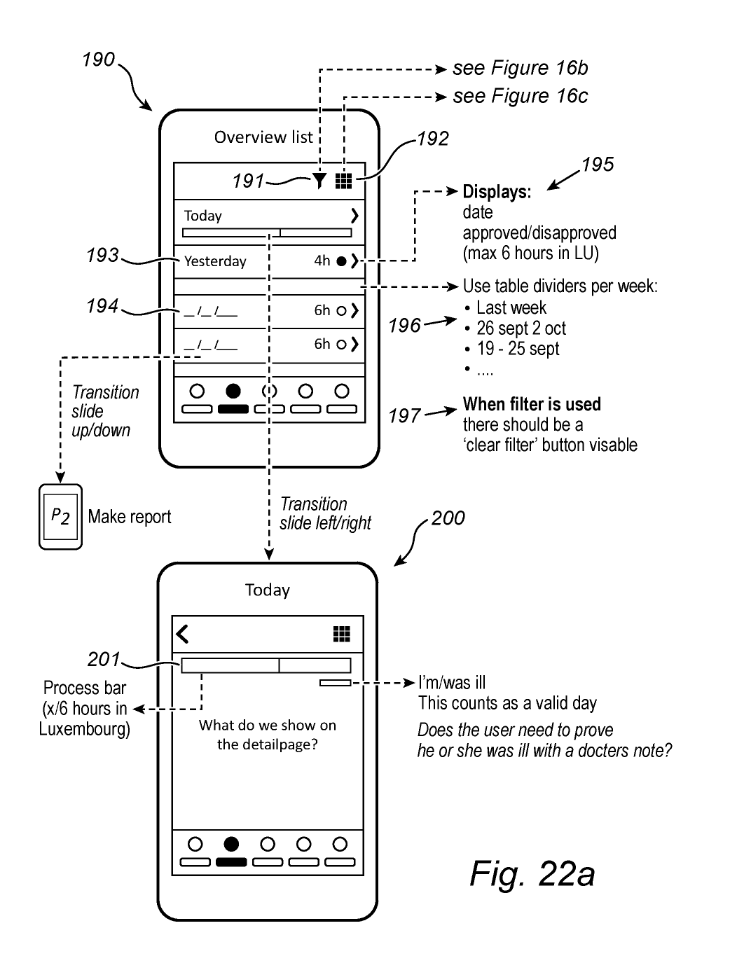

FIGS. 20 to 25 show diverse views of an example of an embodiment of a mobile application corresponding to the present invention. This mobile application, also called “My Tax Locator Application” in the context of the present invention, is intended for use by the employee. The mobile application is run on the mobile device of the employee; in the exemplary architecture of EXAMPLE 6, it is mobile device 316. The mobile device is supposed to be worn by the employee.

Prior to the use of the mobile application, the employee receives an invitation mail. The mail contains a download link where the application can be downloaded, as well as an activation link. The aim is that the employee first downloads the application, and only then uses the activation link. The activation link itself comprises:
a deep link to the application, including a unique ID; and/or
a link to a QR code (or other one-/two-dimensional bar code), including a unique ID.

FIG. 20 illustrates the home page 140 shown when the mobile application is opened for the first time. To this end, the employee must first have downloaded the mobile application to his mobile device. Subsequently, the employee can swipe to the left 142 and swipe to the right 143 to see different notes on how the application works. After swiping through all of the notes, the employee is led 144 to the setup screen 150. Alternatively, the employee can navigate directly to the setup screen 150 via the button 141 stating “get started” 145.

FIG. 20 also illustrates the setup screen 150; comprising several fields 151 that have to be filled in with diverse values 152 such as the first name, name, street and number, postal code and town/community, country , biometric data (whether or not with scan of the fingerprint) and/or a numeric code, a calendar. After receiving this information, the employee will see the home page 160.

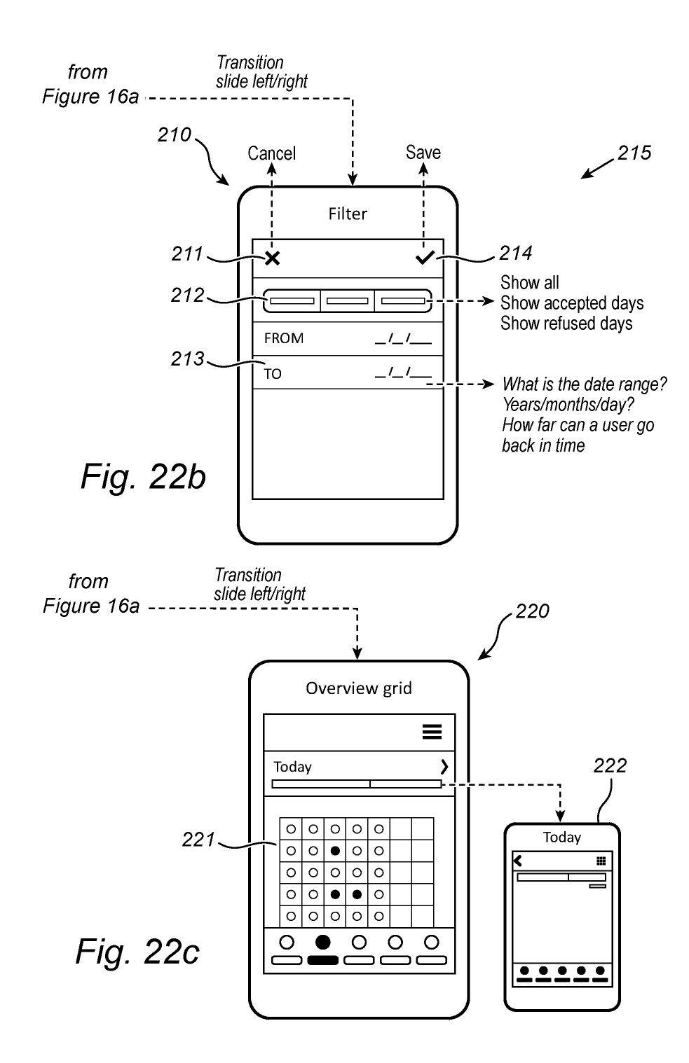

FIG. 21a illustrates the home page 160. This screen shows in the first place a navigation bar 161. By shifting this navigation bar 161 horizontally, the employee of the home page 160 is led to the overview list screen 190 and vice versa. The navigation bar 161 also indicates the number of hours that have already been registered today 167, in which the registration relates to the registration of location information and time information corresponding to the present invention. The button 162 with symbolic illustration of an eye is a switch button allowing to switch on and off 168 the registration. When the employee switches off the registration, a confirmation screen is shown. The button 162 is also associated to a status indication 163 that shows until which moment the present situation (registration on or off) lasts 169. This can overrule the default calendar settings (such as adjustable via the availability screen 230) once. When the registration has been switched off via button 162, the status indication 163 must indicate on which date and at which time the registration will start again 170. The home page 160 further shows a do-not-disturb field 164 leading to the do-not-disturb screen 170, as well as a make-report field 165 leading to the make-report screen 180. Both fields 164 and 165 can be reached by sliding downwards and upwards, as a result of which the respective screens 170 and 180 are brought forward.

FIG. 21b illustrates the do-not-disturb screen 170. Here, the employee can set during which period he/she does not want to be disturbed, i.e. during which period he/she wishes no registrations are made. This is possible with a relative time indication: for an hour 172, for two hours 173 and because of sickness, for the present day 174. This is also possible with an absolute time indication, till a particular, adjustable hour 175. Icons in the upper corners allow to save the settings 176 or to cancel the setting of respective period 171.

FIG. 21c illustrates the make-report screen 180. Here, the employer can indicate that a report must be generated of the location and time information that has been registered from him. Also, he can indicate to which period the period has to relate, with a starting date (FROM) and an end date (TO) 182. The screen zone 183 shows to which mail address the report to generate will be sent. Icons in the upper corners allow to generate and send the report 184 or to cancel the generation of a report 181.

FIG. 22a illustrates the overview-list screen 190. A horizontal bar on top of the screen comprises a filter icon 191 and a grid icon 192. Sliding horizontally over this horizontal bar brings the employee to the filter screen 210 or the overview-grid screen 220. The overview-list screen 190 further comprises a selectable zone ‘Today’ that leads, by sliding horizontally, to the today screen 200, as well as a selectable zone ‘Yesterday’ 193. This zone 193 also gives the number of hours that has been approved/rejected 195 (in this example with respect to a maximum of 6 hours in Luxembourg). Underneath it, a zone 194 has also been provided for earlier days, that are subdivided per week 196. When a filter is active, a ‘clear filter’ button is also visible 197. As mentioned earlier, the make-report screen 180 can be reached from the overview-list screen 190 and vice versa, by sliding upwards or downwards.

FIG. 22a further illustrates the today screen 200, showing a process bar 201. This process bar 201 shows the part of hours that the employee has stayed within a particular tax authority (in this example Luxembourg). This part is shown relatively with respect to a maximum of 6 hours. Moreover, this process bar 201 is also shown in miniature in the selectable zone ‘Today’ in the overview-list screen 190. The today screen also has a separate zone in which it can be indicated that the employee is/was sick.

FIG. 22b illustrates the filter screen 210, that can be reached from the overview-list screen 190 by sliding horizontally. The filter screen 210 allows the employee to indicate which registrations have to be shown in the overview-list screen 190. Via the zone 212, one can choose to show all the days, of only the accepted or refused days. Via the zone 213, a period can be set, with a starting date (FROM) and an end date (TO). Icons in the upper corners allow to save the setting values 214 or to cancel the setting of the filter 211.

FIG. 22c illustrates the overview-grid screen 220. A grid zone 221 shows for each day the status with respect to registrations by means of a circular icon. In this example, each row of the grid zone 221 corresponds to a particular week, and only the first five days (Monday until Friday) are provided with said circular icon, corresponding to the exemplary days on which has been worked. The overview-grid screen 220 further comprises a selectable zone ‘Today’ that leads, by sliding horizontally, to said today screen 200.

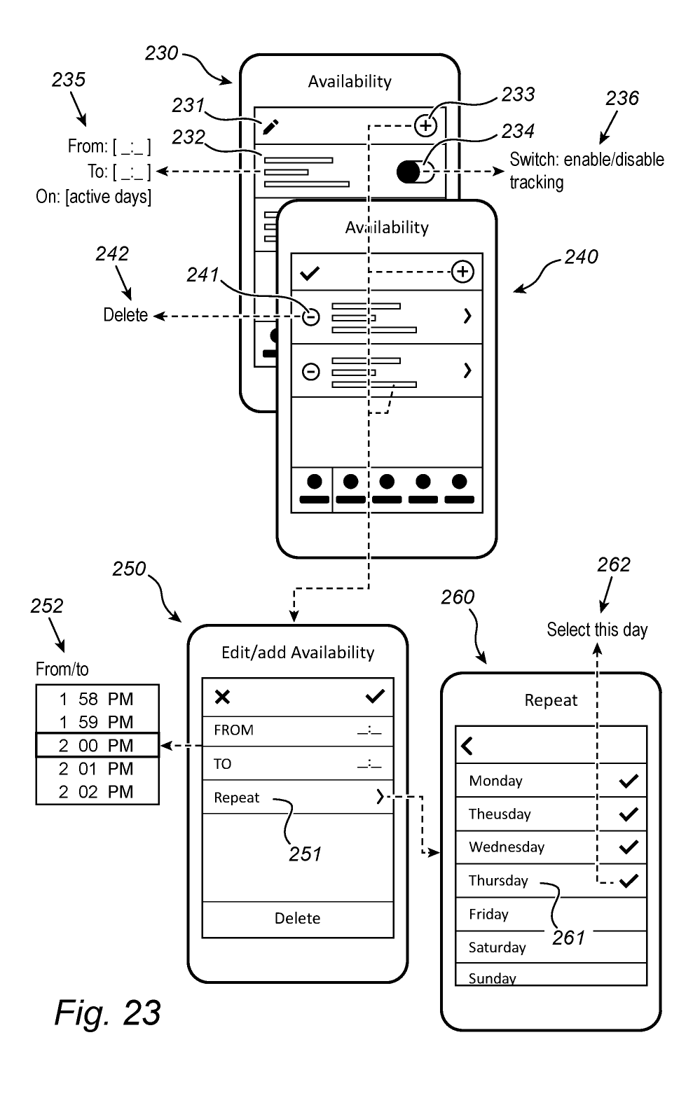

FIG. 23 illustrates a first and second view 230 and 240 of the availability screen, in which the employee can set his/her availability. The first view 230 shows a list 232 of agenda items. Each agenda item is characterized by a particular period of time with a starting moment (FROM) and an end moment (TO) 235. For each agenda item, a switch 234 can indicate if a registration has to be made 236 within the indicated period. The upper corners of the first view 230 contain at the left and the right an ‘edit’ icon 231 and an ‘add’ icon 233. The ‘edit’ icon leads to the second view 240, in which for each agenda item, a ‘delete’ icon 241 appears, allowing to delete the respective agenda item 242. The ‘add’ icon 233 allows to add a new agenda item via the edit-add-availability screen 250; the ‘add’ icon 233 is also visible in the second view 240.

FIG. 23 further illustrates the edit-add-availability screen 250 and the repeat screen 260. The edit-add-availability screen 250 allows to specify the period of time for a new agenda item that must be created, with a starting moment (FROM) and an end moment (TO) 252. It can also be indicated if the agenda item must be repeated 251. The latter is possible via a separate repeat screen 261, with a listing of the week days 261 that can be selected individually 262.

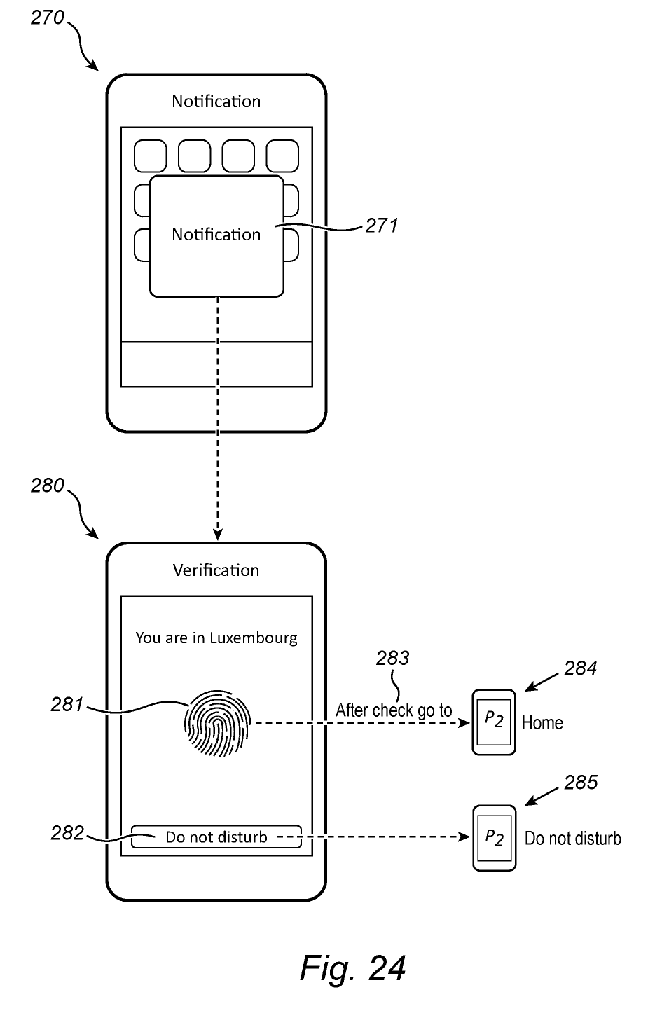

FIG. 24 illustrates the notification screen 270 that is shown to the employee, and essentially comprises a push notification 271, with a request for verification. The verification consists of scanning the fingerprint of the employee by the system, which, in case it is valid, is confirmed by the verification screen 280. In a preferred embodiment, such as for example illustrated with EXAMPLE 5, such push notifications 271 are shown according to an at least partially arbitrary scheme. As described in the present document, the verification has in this way the value of an arbitrary sampling, which helps to prevent abuse of the system. The verification system 280 comprises a state notification, in this case “You are in Luxembourg”, as well as an image of the fingerprint 281. After verification, the employee is led 283 to the home page 60, or alternatively, via the button “Do not disturb” 282, to the do-not-disturb screen 170.

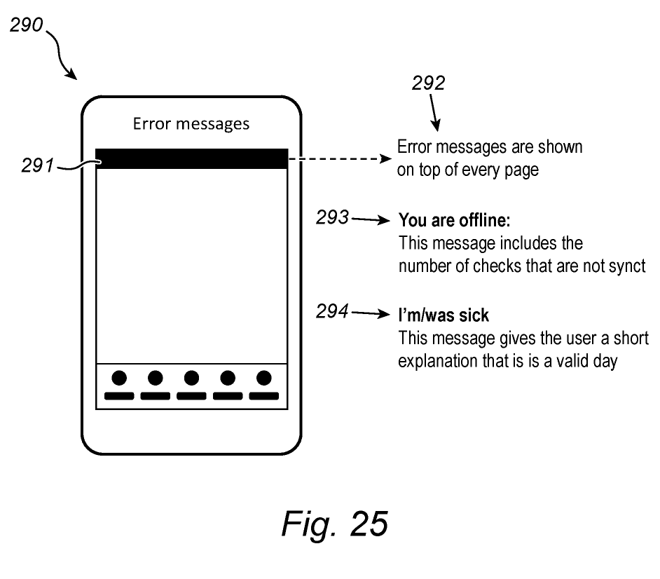

FIG. 25 illustrates the view 290 of error messages. These are shown, when using the mobile application, on top of the screen 292 as a horizontal bar 291. A first possible error message 293, “You are off line”, indicates that the application has no access to the back-end server, and also mentions the number of registrations (or “check-ins” or “checks”) that has not been synchronized yet. A second possible error message 294, “I'm/was sick”, indicates that the employee is/was sick, and give a short explanation as to the fact that it concerns a valid day.

### EXAMPLE 9

This example shows the content of a first and second exemplary report as they can be generated in the context of the present invention. In an exemplary embodiment according to EXAMPLE 8, such reports are generated and sent via icon 184 on the make-report screen 180. Both reports are delivered in a preferred embodiment as a separate document, which is moreover provided with a QR code. The QR code is intended for validating the authenticity of the report. The non-registered days are shown separately in the report and are followed by the following text. “Non-registered days are working days which the mobile application could not certify. This can happen when the mobile device is off line, when the mobile application is not active, or when the user has not authenticate himself/herself.”

The first exemplary report relates to a first variant of the mobile application, intended for situations in which the tax authorities are Belgium and Luxembourg.

First exemplary report - tax authorities Belgium and Luxembourg

| Identification tax payer | |
|---|---|
| Name | John Doe |
| Period | 1/1/2016-31/12/2016 |
| Country of residence | Belgium |
| Number of working days in the period | |
| Number of days in the period | 366 |
| Number of days in the weekend | 105 |
| Number of non-working days | 49 |
| (legal) holidays, days of sickness, compensation | |
| days | |
| Total number of working days in the period | 212 |
| Overview (<name contract>) | |
| Country of work | Luxembourg |
| Number of working days in Luxembourg | 212 |
| Number of non-registered days | 5 |
| Number of days spent outside Luxembourg | 17 |

The second exemplary report relates to a second variant of the mobile application, in which the employee is an expat for a particular employer.

Second exemplary report - expat

| Identification tax payer | |
|---|---|
| Name | John Doe |
| Period | 1/1/2016-31/12/2016 |
| Employer | <name employer> |
| Number of working days in the period | |
| Number of days in the period | 366 |
| Number of days in the weekend | 105 |
| Number of non-working days | 49 |
| communicated by <name employer> | |
| (legal) holidays, days of sickness, compensation | |
| days | |
| Total number of working days in the period | 212 |
| Overview | |
| Total number of working days in the period | 212 |
| Number of non-registered days | 5 |
| Number of days abroad | 43 |

1. Computer-implemented method for reporting to a server location information and time information of an employee within the framework of a tax declaration, in which said method comprises:
determining an identity of the employee by means of a mobile device belonging to said employee;
determining said location information of the employee based on a localization of said mobile device, in which the location information comprises a first and a second location;
determining time information comprising a first and second period by means of said mobile device, in which, during the first period, the employee falls under a first tax authority linked to the first location and during the second period, falls under a second tax authority linked to the second location;
registering said location information and said time location on said mobile device;
transferring said registered location information and said time information to said server within the framework of said tax declaration;
wherein said determination of the identity comprises a biometric authentication based on a biometric template, in which said biometric template is present only on said device, in which said registration of said location information and said time information takes place at least once a day, and in which said determination of the identity, location information and time information and said registration takes place without said mobile device being linked to said server.

2. Method of claim 1, wherein said determination of time information takes place based on a source for independent time determination, such as a certified time source or a GNSS (global navigation satellite system).

3. Method of claim 1, wherein the registration of said location information and said time information takes place at least twice an hour, preferably at least three times an hour.

4. Method of claim 1, wherein the request for said biometric authentication at said employee takes place at least partially without the employee being able to predict this, and preferably at least once a month.

5. Method of claim 1, wherein the request for said biometric authentication at said employee is triggered by said registration of location information, preferably when detecting a change of a tax authority linked to said location information.

6. Method of claim 1, wherein the request for said biometric authentication is made less frequently as the level of trust corresponding to said employee increases, in which said level of trust depends at least on the validity of a number of recent biometric authentications, such as the validity of the three most recent biometric authentications.

7. Method of claim 1, wherein said registration of said location information and said time information comprises an indication of the validity of a present and/or recent biometric authentication.

8. Method of claim 1, wherein said determination of the identity comprises a first local authentication mechanism concerning said biometric authentication and a second local authentication mechanism concerning a PIN authentication (Personal Identification Number).

9. Method of claim 1, wherein said determination of the identity takes place according to FIDO (Fast Identity Online) Alliance UAF specification set (Universal Authentication Framework) and/or U2F specification set (Universal Second Factor) comprising a first local authentication mechanism and optionally a second local authentication mechanism, in which said first local authentication mechanism relates to said biometric authentication, and in which said second local authentication mechanism relates to the use of a PIN and/or a dongle, preferably a USB dongle.

10. Method of claim 1, wherein said localization can be obtained with a GNSS such as GPS (Global Positioning System) and/or GSM triangulation (Global System for Mobile Communications).

11. Method of claim 1, wherein said determination of identity, location information and time information and said registration takes place without the mobile device being connected to the Internet.

12. Method of claim 11, wherein said determination of identity takes place only locally on the mobile device, and that said determination of location information and time information takes place only based on an interaction between said mobile device and a GNSS.

13. System for the reporting to a server of location information and time information of a plurality of employees within the framework of one or more tax declarations; said system comprising a server and a plurality of mobile devices; said server and each of said plurality of mobile devices comprising a processor, tangible non-volatile memory, instructions stored on said memory for controlling said processor, a mobile application; in which for each mobile device, the mobile application is configured for carrying out a method of claim 1.

14. System of claim 13, in which an identity of an employee for at least one of the employees is linked one-to-one to the mobile application on the mobile device belonging to said employee.

15. Use of the method for the reporting to a server of location information and time information of an employee within the framework of a tax declaration according to claim 1 for the calculation of a tax arrears corresponding to said employee and/or an employer associated to said employee, in which said tax arrears relate to said tax declaration, and in which said tax arrears is calculated at least partially based on said reporting to the server of location information and time information of said employee.

16. Use of the method for the reporting to a server of location information and time information of an employee in the system of claim 13 for the calculation of a tax arrears corresponding to said employee and/or an employer associated to said employee, in which said tax arrears relate to said tax declaration, and in which said tax arrears is calculated at least partially based on said reporting to the server of location information and time information of said employee.
